(19) United States
(12) Patent Application Publication
(10) Pub. No.: US 2026/0310340 A1
(43) Pub. Date: Oct. 8, 2026

(54) GENERATING A UNIVERSAL-CONTENT-INTEGRATION TOOL FOR A CONTENT ITEM

(71) Applicant: Dropbox, Inc., San Francisco, CA (US)

(72) Inventors: Alessandro Battisti, New York, NY (US); Yujung Kade Son, Brooklyn, NY (US); Nicole Eskandari, Los Angeles, CA (US); Paula Barcante, Victoria (CA); Sabrina Weschler, Seattle, WA (US); James Robert Cailotto, Seattle, WA (US)

(21) Appl. No.: 19/098,151

(22) Filed: Apr. 2, 2025

(51) Int. Cl. G06F 3/04845; G06F 3/0482; G06T 11/60

(52) U.S. Cl. CPC G06F 3/04845; G06F 3/0482; G06T 11/60

(57) ABSTRACT

The present disclosure relates to systems, non-transitory computer-readable media, and methods for generating a universal-content-integration tool that overlays on a content item displayed on a client device. In particular, in one or more embodiments, the disclosed systems can generate engagements and responses for the content item based on user interactions with the universal-content-integration tool. In some embodiments, based on user interactions with the universal-content-integration tool, the disclosed systems utilize a large language model to generate a response for a content item or generate location-specific comments for the content item. Moreover, in one or more embodiments, the disclosed systems can also update the content item by updating statuses, share permissions, and making modifications to the content item through the universal-content-integration tool.

### BACKGROUND

Recent years have seen significant improvements in storage systems that can synchronize and store digital items (e.g., computer data and files) across multiple devices and systems. For example, existing systems can store data and digital items on servers and synchronize the data and digital items to computing devices, and vice versa, syncing data and digital items stored on computing devices to servers. To illustrate, existing systems can synchronize modifications of a content item so that accessing the content item directly from either the server or from the computing device would result in viewing updated versions of both instances of the content item. Although existing systems can synchronize content items across devices and servers, such systems have a number of problems in relation to excessive user interface interactions required to share and update content and efficiency and flexibility of operation.

As just mentioned, existing systems require excessive user interface interactions to share content items. For example, when a user desires to share a content item that is displayed in a third-party application, a user must navigate through multiple user interfaces to identify a storage location for the content item, then finally performing even more user interface interactions to share the content item. In addition, when multiple users are collaborating on a content item, a user must often perform these excessive navigations multiple times to share the content item with multiple users. Furthermore, a user must also perform excessive navigations to update share permissions for a content item, executing and navigating through multiple interfaces to generate or modify share permissions for a content item.

In addition, existing systems are inefficient. In particular, in part due to the excessive user interface interactions required to share content, existing systems require excess computing power as client devices initiate multiple interfaces and perform multiple interactions to share content items. For example, each time a user must execute an additional interface, it often requires loading new UI elements, retrieving data from storage or a server, and rendering graphics, all of which consume excessive processing resources. In addition, each additional interaction can trigger background processes such as UI animations, network requests, and memory allocation, leading to excessive processing power consumption.

In addition, existing systems are inflexible. Specifically, though existing systems can share content items, a user receiving a content item can only access the content item if the user has an application corresponding to the file type of the content item. If the receiving user does not have an application corresponding to the file type of the content item, the user is unable to view the content item and any information or content within the content item. For example, users of existing systems often use different applications that correspond to different specialties but require the approval of another user for the content item. In order to share the content item with a user without the corresponding application, a user must generate a PDF or create a screenshot of the content item and share that with the other user in order to receive feedback or approval.

### SUMMARY

This disclosure describes one or more embodiments of systems, methods, and non-transitory computer-readable storage media that provide benefits and/or solve one or more of the foregoing and other problems in the art. For instance, the disclosed systems generate a universal-content-integration tool that overlays on a content item displayed on a client device and generates engagements and responses for the content item. For example, the disclosed systems generate responses for the content item in response to a user interaction with a large language model analysis option within the universal-content-integration tool. In addition, as another example, the disclosed systems generate comments for the content item through interactions with the universal-content-integration tool that renders comments at specific locations across various applications. Moreover, in some instances, the disclosed systems can also update the content item by updating statuses, sharing permissions, and making modifications to the content item through the universal-content-integration tool.

### BRIEF DESCRIPTION OF THE DRAWINGS

The detailed description provides one or more embodiments with additional specificity and detail through the use of the accompanying drawings, as briefly described below.

FIG. 1 illustrates an example diagram of an overview of a universal content integration system generating a universal-content-integration tool in accordance with one or more embodiments.

FIG. 2 illustrates a schematic diagram of a universal content integration system generating a universal-content-integration tool overlaid on a content item within a third-party application and utilizing a large language model to generate a response corresponding to a content item displayed in the third-party application in accordance with one or more embodiments.

FIGS. 3A-3B illustrate example graphical user interfaces of a universal-content-integration tool overlaid on a content item in accordance with one or more embodiments.

FIGS. 4A-4C illustrate example graphical user interfaces of a universal content integration system generating a universal-content-integration tool that is specific to an application or content item in accordance with one or more embodiments.

FIG. 5 illustrates an example graphical user interface and various options of a universal content integration system using a universal-content-integration tool to generate engagements and responses for a content item in accordance with one or more embodiments.

FIGS. 6A-6C illustrate example graphical user interfaces of a universal content integration system using a universal-content-integration tool to generate location-specific comments for a content item in accordance with one or more embodiments.

FIG. 7 illustrates an example graphical user interface for a universal content integration system using a universal-content-integration tool to generate responses for a content item in accordance with one or more embodiments.

FIG. 8 illustrates an example graphical user interface of a universal content integration system displaying content integrations from a universal-content-integration tool on a content item in accordance with one or more embodiments.

FIGS. 9A-9B illustrate an example graphical user interface of a universal content integration system generating a drop zone tool to store and share content items in accordance with one or more embodiments.

FIG. 10 illustrates a diagram of an environment in which a universal content integration system can operate in accordance with one or more embodiments.

FIG. 11 illustrates a flowchart of a series of acts for generating and utilizing a universal-content-integration tool in accordance with one or more embodiments.

FIG. 12 illustrates a flowchart of a series of acts for generating a universal-content-integration tool to generate location-specific comments in accordance with one or more embodiments.

FIG. 13 illustrates a block diagram of an example computing device for implementing one or more embodiments of the present disclosure.

FIG. 14 illustrates a network environment of a content management system in accordance with one or more embodiments.

### DETAILED DESCRIPTION

This disclosure describes one or more embodiments of a universal content integration system that generates a universal-content-integration tool overlaid on a content item rendered on a client device to generate dynamic omnichannel engagements and responses for the content item. For instance, in one or more embodiments, the universal content integration system generates the universal-content-integration tool within an application (e.g., a third-party application) displaying a content item on a client device. Based on user interactions with the universal-content-integration tool, the universal content integration system generates various engagements with the content item and utilizes a large language model to generate responses corresponding to the content item. For example, through the universal-content-integration tool, the universal content integration system generates location-specific comments, generates summaries, generates task lists, updates statuses, updates share permissions, and displays user accounts associated with the content item.

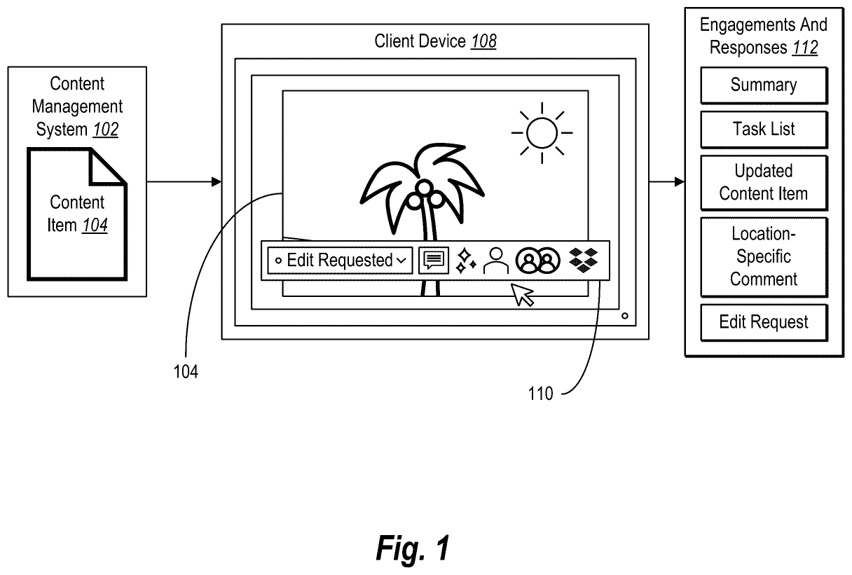

FIG. 1 illustrates an example overview of universal content integration system 100 utilizing a universal-content-integration tool to generate engagements and responses for a content item. As shown, the universal content integration system 100 can access content item 104 at content management system 102. In particular, the universal content integration system 100 is integrated within (or associated with) content management system 102 and can access content item 104. For example, content item 104 can be stored at a cloud storage location of content management system 102, and the universal content integration system 100 can identify when an application accesses content item 104. An application that accesses content item 104 can be an application associated with the content management system 102 or a third-party application associated with a file type of the content item (e.g., Microsoft Word for a .doc or .docx file).

As shown, the universal content integration system 100 generates universal-content-integration tool 110 overlaid on content item 104 displayed on client device 108. In particular, the universal content integration system 100 generates universal-content-integration tool 110 within an application on client device 108 displaying content item 104. For example, the universal-content-integration tool 110, can receive user interface interactions to generate engagements and responses for content item 104 within the application. Further, the universal content integration system 100 can generate universal-content-integration tool 110 within an application associated with the content management system 102 or a third-party application.

In addition, as shown, based on the user interactions with the universal-content-integration tool 110, the universal content integration system 100 generates engagements and responses 112. For example, as shown, the universal content integration system 100 generates summaries, task lists, and location-specific comments for the content item 104 based on user interactions with universal-content-integration tool 110. Additionally, the universal content integration system 100 can update content item 104 and receive statuses and edit requests within universal-content-integration tool 110 and update statuses and provide indications of edit requests for the content item within the content management system.

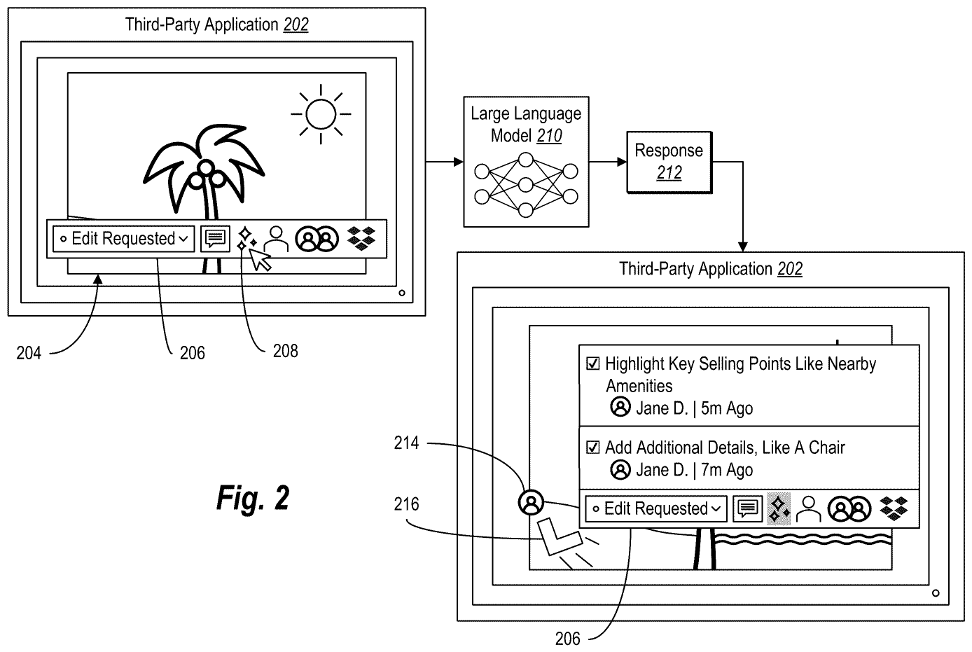

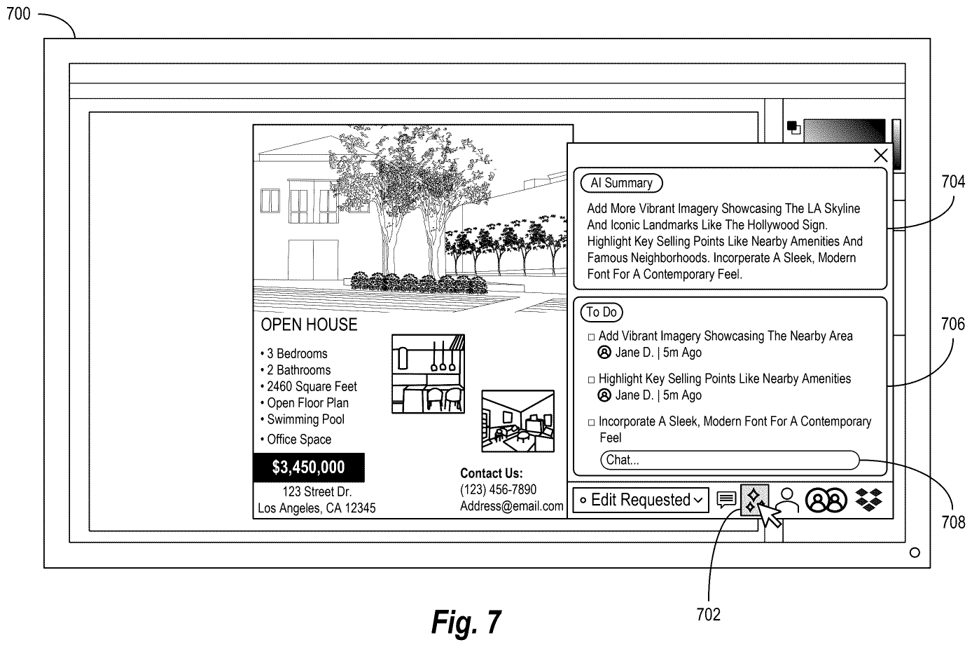

For instance, in one or more embodiments, the universal content integration system 100 utilizes a large language model to analyze the content item to generate a response. Specifically, based on a user interaction with a large language model analysis option within the universal-content-integration tool 110, the universal content integration system 100 utilizes a large language model to analyze content item 104 and generate a response. For example, the universal content integration system 100 can generate a response corresponding to content item 104, such as a summary of content item 104. As another example, the universal content integration system 100 can generate a response based on user interactions with other options of the universal-content-integration tool. To illustrate, the universal content integration system 100 can generate a summary of comments or a task list from user interactions with content item 104 (e.g., from other client devices that are associated with content item 104). Additional details regarding the universal content integration system 100 utilizing a large language model to generate a response for a content item are provided below with respect to FIG. 2. In addition, example interfaces of the universal content integration system 100 utilizing a large language model to generate responses are provided below with respect to FIG. 7.

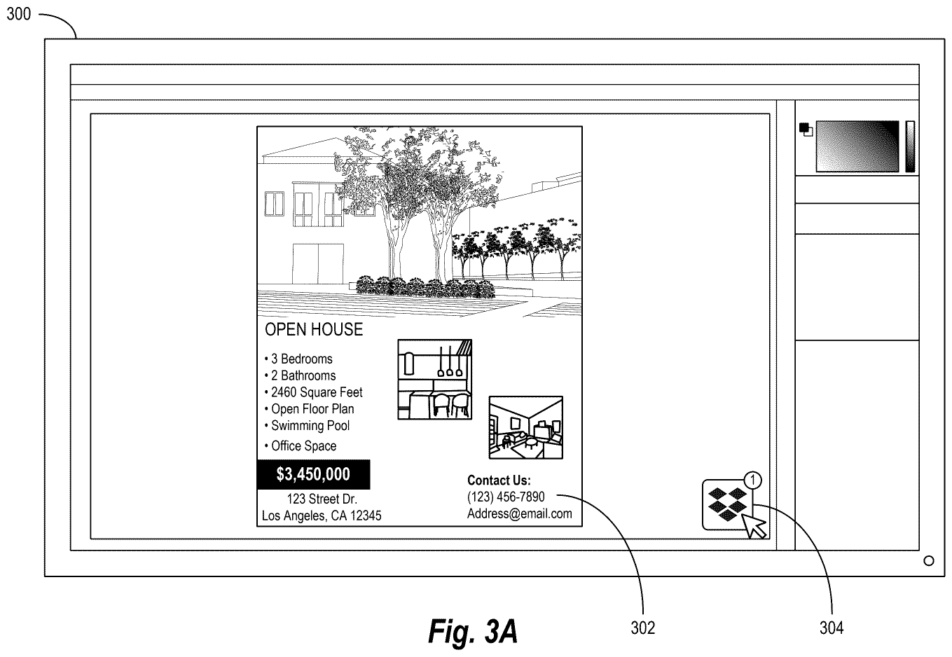

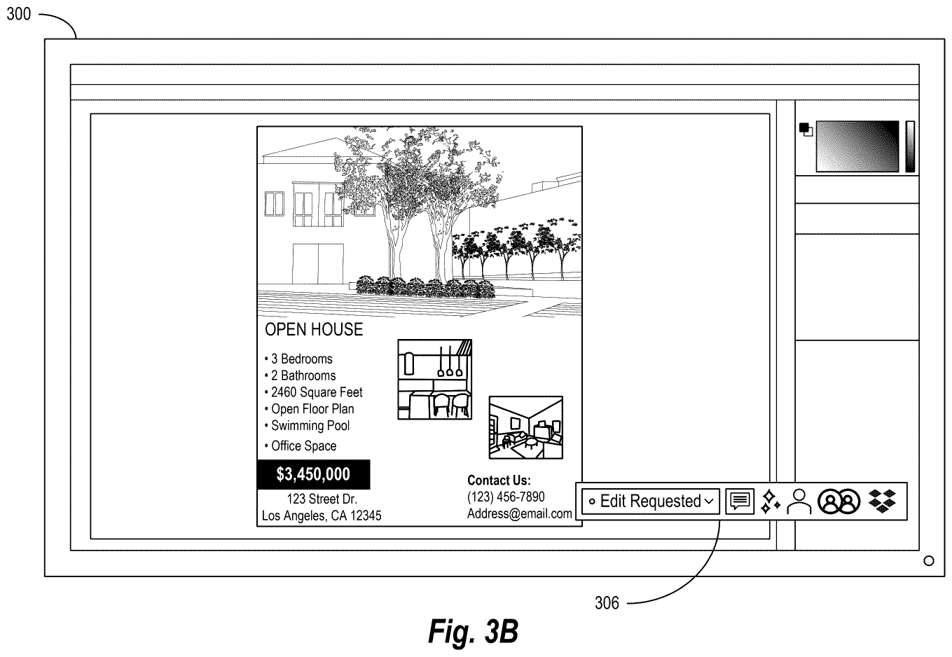

As previously mentioned, the universal content integration system 100 generates a universal-content-integration tool 110. In particular, the universal content integration system 100 interacts with a third-party application rendering or displaying content item 104 to generate the universal-content-integration tool 110 as a user interface component overlaid on content item 104. For example, the universal content integration system 100 utilizes an application programming interface to generate the universal-content-integration tool 110 as an interface component that is separate from the third-party application but can move within the boundaries of the third-party application (e.g., overlaid on top of the content item but confined within the third-party application). Additional details regarding the universal content integration system 100 generating a universal-content-integration tool are provided below with respect to FIGS. 3A-3B.

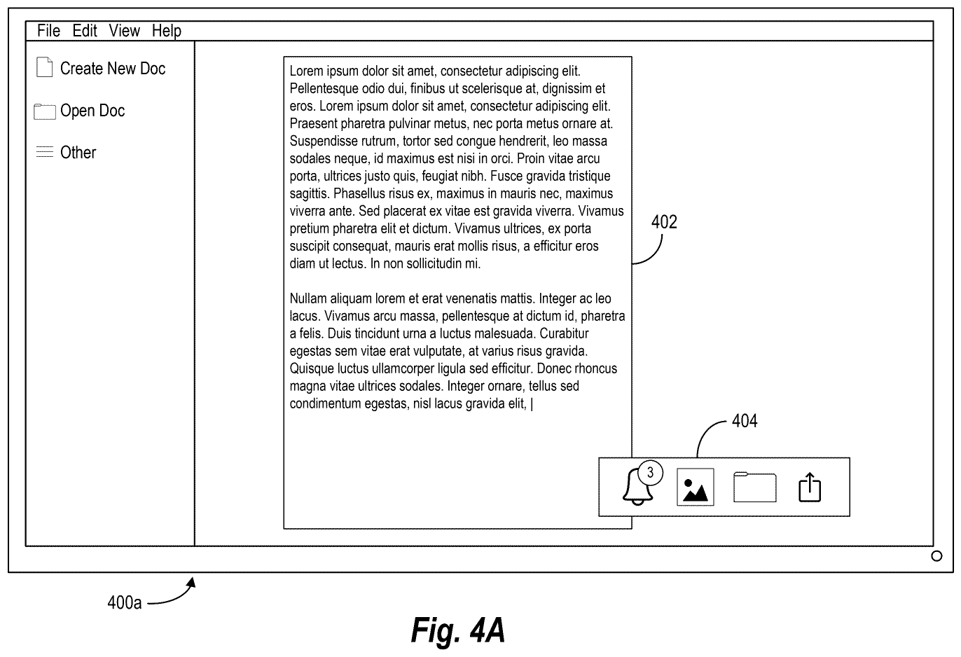

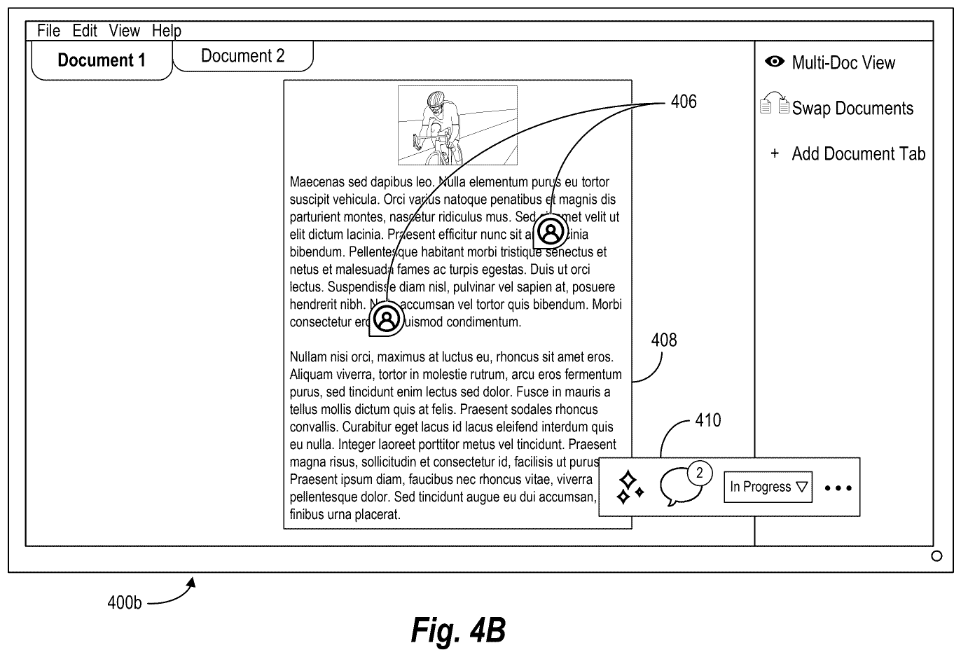

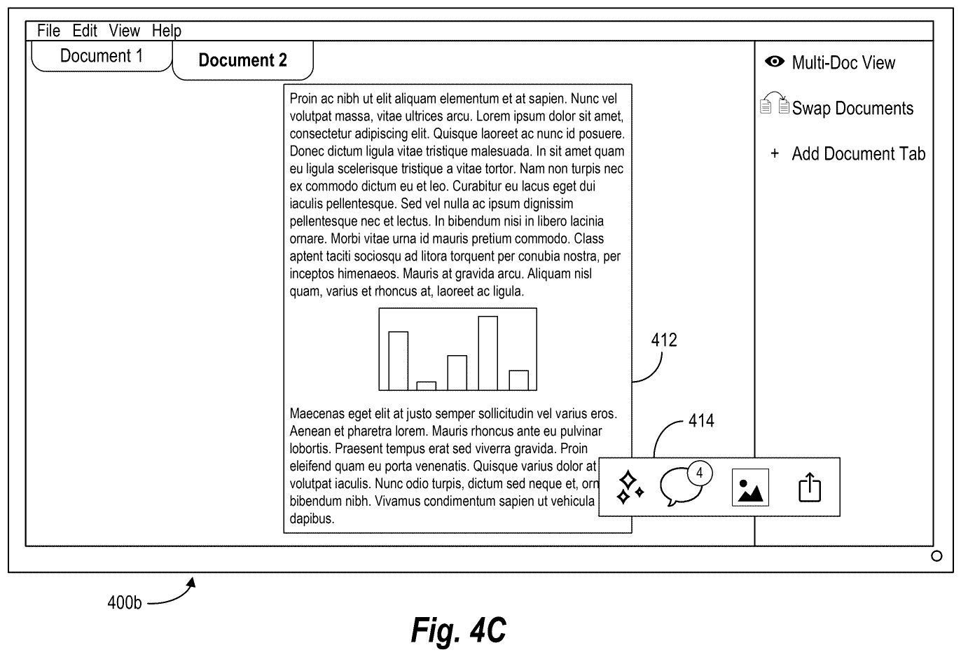

In one or more embodiments, the universal content integration system 100 generates a universal-content-integration tool that corresponds to an application or a content item. More specifically, the universal content integration system 100 can generate a universal-content-integration-tool that is specific to an application or a content item and includes options that are unique to the application or content item. Additional details regarding the universal content integration system 100 generating a universal-content-integration tool that is specific to an application or content item are provided below with respect to FIGS. 4A-4C.

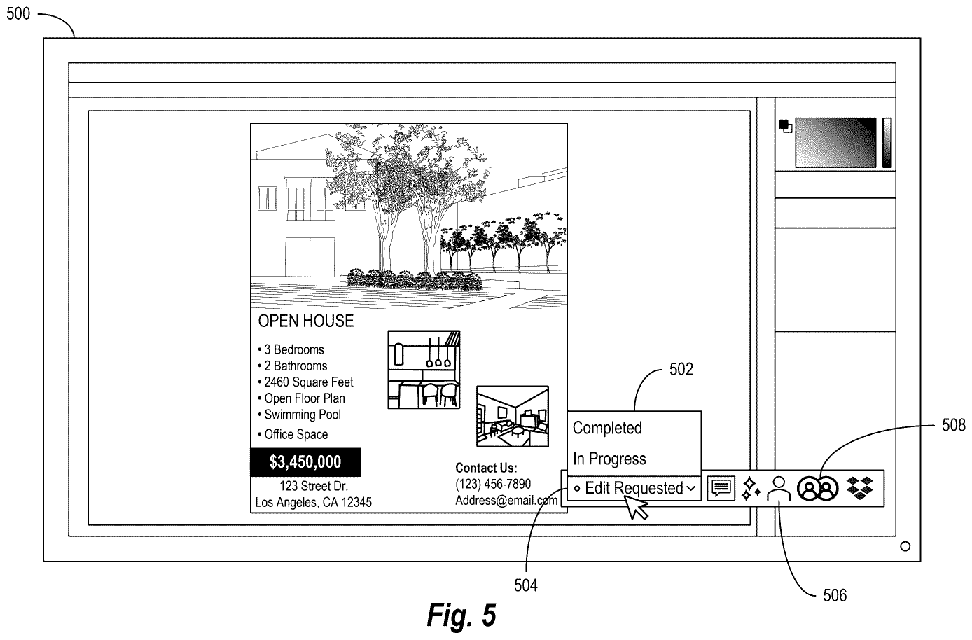

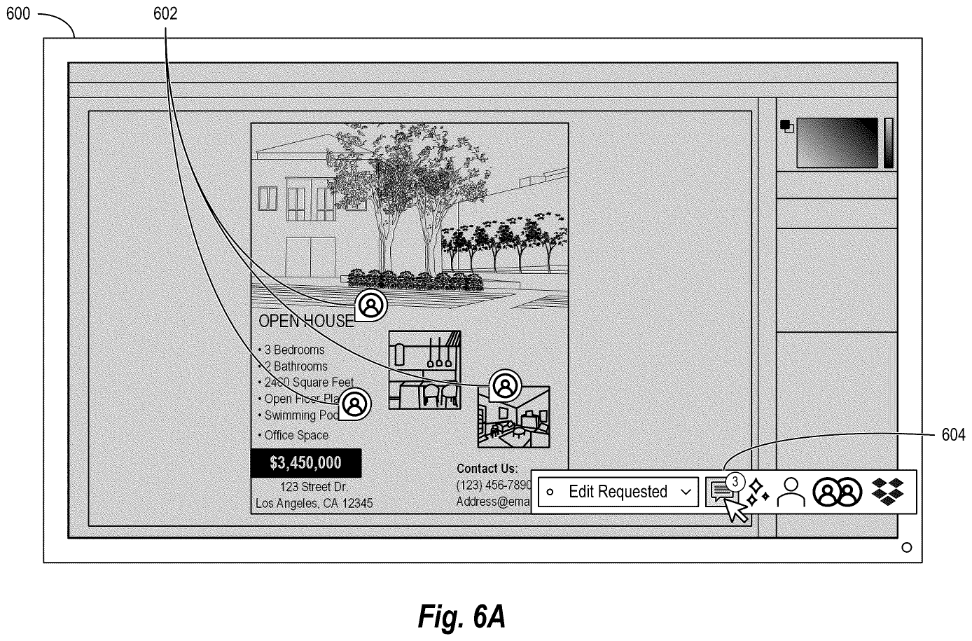

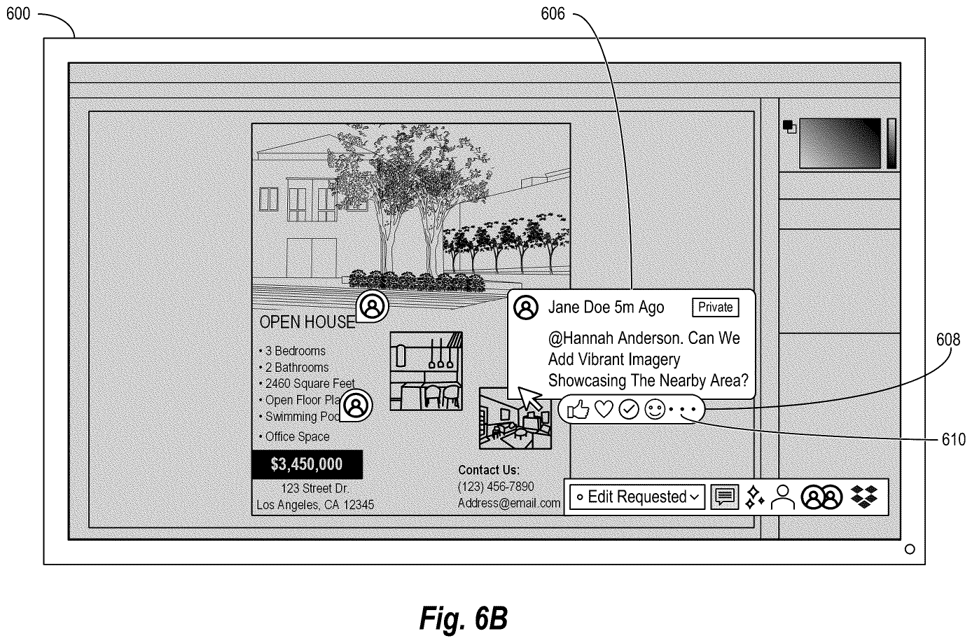

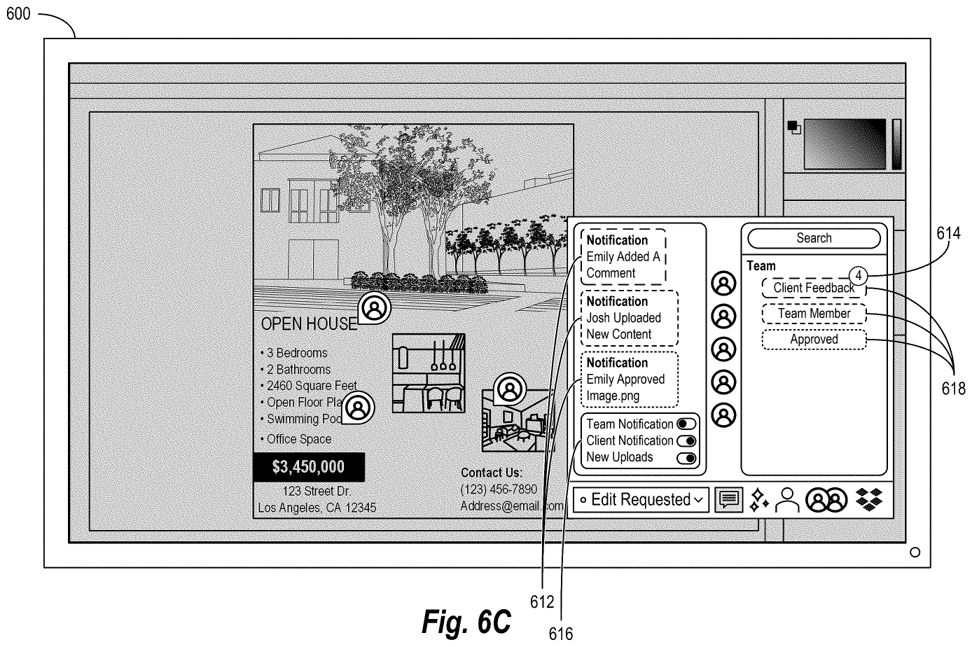

Further, in some embodiments, the universal content integration system 100 receives user interactions to update statuses of content item 104 with content management system 102. Specifically, the universal content integration system 100 receives user interactions selecting or defining a status for content item 104 that is synchronized to the content management system 102. For example, the universal content integration system 100 can provide a status option of universal-content-integration tool 110 that indicate a status for content item 104, such as review statuses (e.g., requesting edits for content item 104). As another example, the universal content integration system 100 can provide a share option of universal-content-integration tool 110 for share permissions for content item 104 (e.g., user accounts with which content item 104 is shared). Additional details regarding the universal content integration system 100 updating a status for a content item are provided below with respect to FIG. 5. Moreover, in one or more embodiments, the universal content integration system 100 generates location-specific comments for content item 104. Specifically, the universal content integration system 100 generates location-specific comments that overlay on content item 104 at a location within content item 104 indicated by a user interaction. For example, based on a user interaction with a location-specific comment option of universal-content-integration tool 110, the universal content integration system 100 provides an option to receive user interactions corresponding to a location within content item 104 and an option to receive user input of comments corresponding to the location. Additional details regarding location-specific comments are provided below with respect to FIGS. 6A-6C.

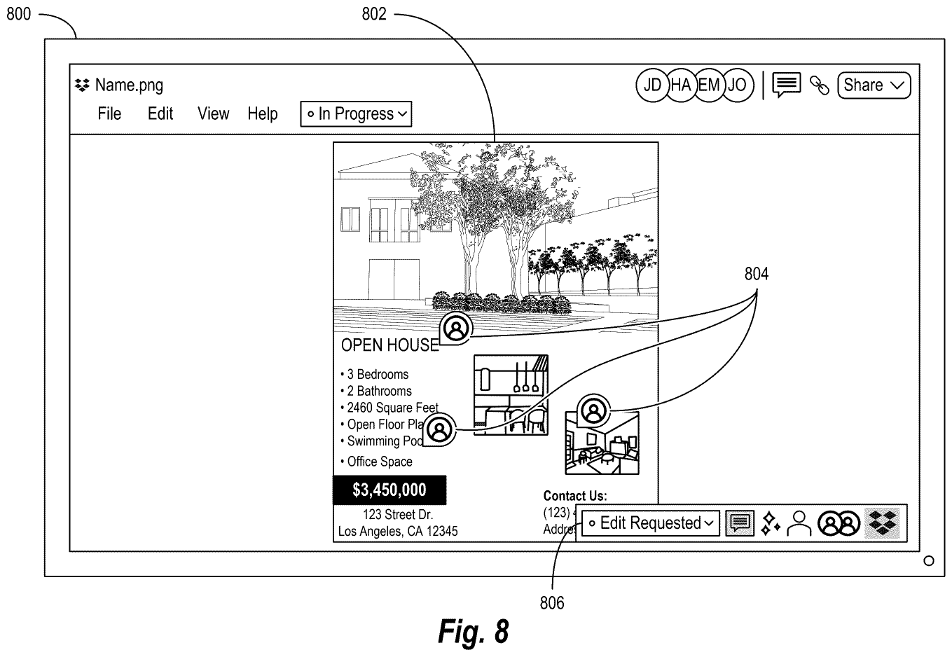

Additionally, in some embodiments, the universal content integration system 100 provides responses and engagements for content item 104 across multiple applications. Specifically, the universal content integration system 100 synchronizes responses and engagements with content item 104 that are overlaid on content item 104 when content item 104 is accessed in multiple applications. For example, the universal content integration system 100 displays location-specific comments at locations and reflects status updates and user accounts interacting with content item 104. Additional details regarding the universal content integration system 100 providing responses and engagements from user interactions with the universal-content-integration tool 110 across multiple applications are provided below with respect to FIG. 8.

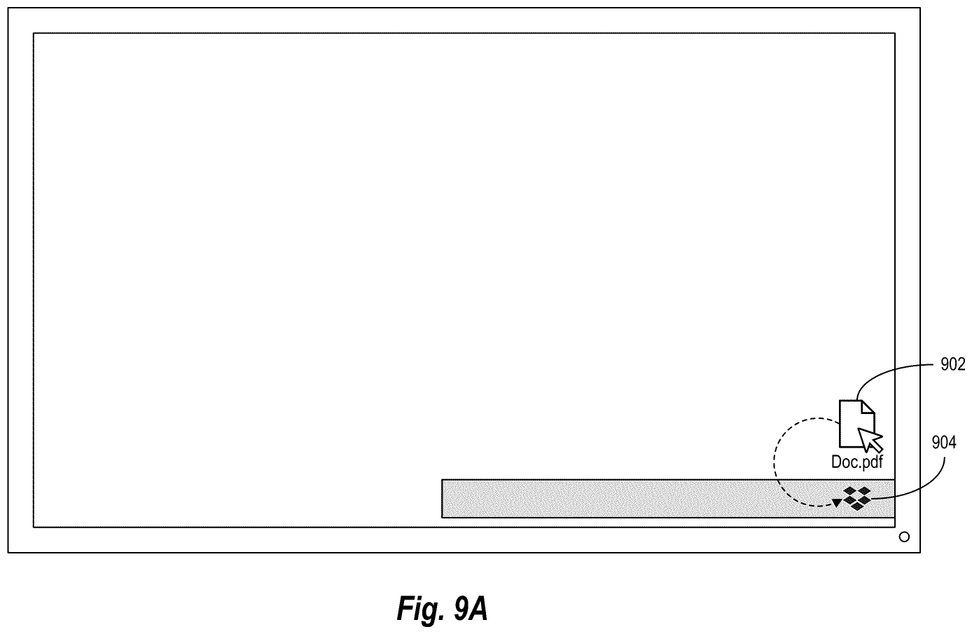

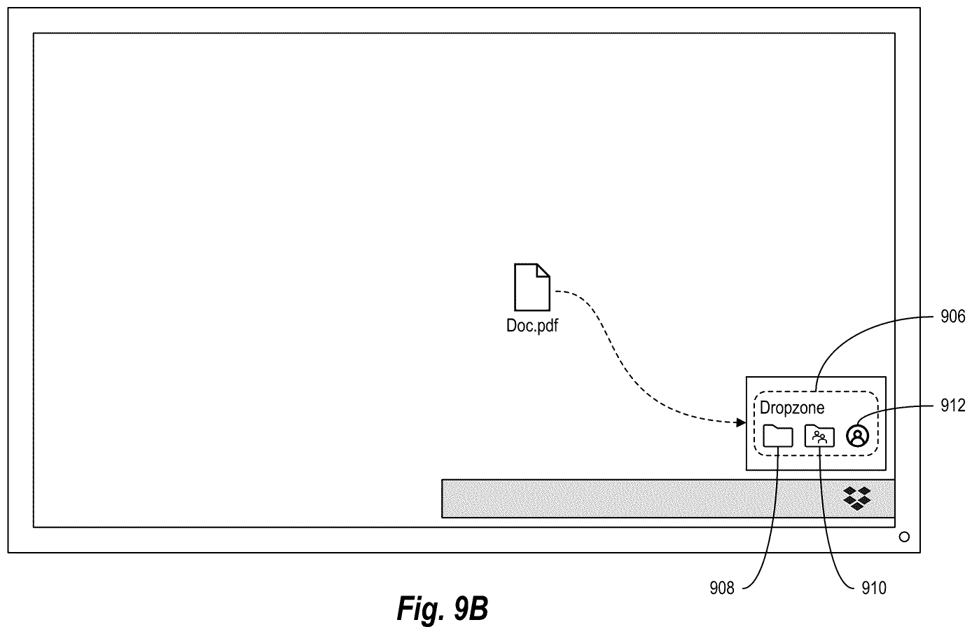

Furthermore, the universal content integration system 100 can provide storage options for content item 104 within a system menu bar. Specifically, based on a user interaction with an icon in the system menu bar, the universal content integration system 100 generates a drop zone tool to add content to the content management system 102. For example, the user interaction generates the drop zone tool interface element that allows for a specified action to add content item 104 to the content management system 102. Additional details regarding the universal content integration system 100 generating a drop zone tool are provided with respect to FIGS. 9A-9B.

The universal content integration system provides a variety of technical advantages relative to existing systems. For example, by generating a universal-content-integration tool overlaid on a content item, the universal content integration system 100 requires fewer user interface interactions than existing systems. Specifically, unlike existing systems that require a user to navigate through multiple user interfaces to identify a storage location for a content item, and then even more interactions to share the content item, the universal content integration system 100 generates a universal-content-interaction tool that facilitates sharing a content item from within a third-party application. For example, the universal content integration system 100 generates a universal-content-integration tool as an interface component overlaid on a content item in a third-party application that provides options for sharing the content item without the need to navigate to additional user interfaces. Indeed, through the universal-content-integration tool, the universal content integration system 100 can perform a number of operations from within a third-party application.

In addition, the universal content integration system 100 improves efficiency relative to existing systems. In particular, unlike conventional systems that require excessive computing power to initiate multiple user interfaces to share content items, the universal content integration system 100 reduces the amount of computing power by generating the universal-content-integration tool to share content items. For example, from the universal-content-integration tool overlaid on the client device, the universal content integration system 100 can share the content item in addition to updating share permissions, viewing user accounts interacting with the content item, and updating content item statuses. Because the universal content integration system 100 generates a universal-content-integration tool overlaid on a content item, a user can update a content item without the need to expend additional energy executing additional interfaces and background items.

Further, the universal content integration system 100 improves flexibility relative to existing systems. More particularly, unlike existing systems that require a user to have an application corresponding to the content item type, the universal content integration system 100 can generate engagements and responses for the content item that multiple client devices can view and interact with, regardless of whether they have an application specific to the file type of the content item. For example, the universal content integration system 100 can display a content item in an interface of the content management system with the corresponding engagements and responses for the content item provided by user interactions with the universal-content-integration tool in a separate application.

As illustrated by the foregoing discussion, the present disclosure utilizes a variety of terms to describe features and advantages of the universal content integration system. Additional details regarding the meaning of such terms are now provided. For example, as used herein, the term “content item” or “digital item” refers to a digital object or a digital file that includes information interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents. digital images, digital videos, or digital audio files). In some cases, a content item can refer to a remotely stored (e.g., cloud-based) item or a link (e.g., a link to a cloud-based item or a web-based content item) and/or a content clip that indicates (or links) a discrete selection or segmented portion of content from a webpage or some other content item or source. A content item can be editable or otherwise modifiable and can also be sharable from one user account (or client device) to another. In some cases, a content item is modifiable by multiple user accounts (or client devices) simultaneously and/or at different times.

Moreover, as used herein, the term “machine-learning model” refers to a computer algorithm or a collection of computer algorithms that automatically improve for a particular task through iterative outputs or predictions based on the use of data. For example, a machine-learning model can utilize one or more learning techniques to improve accuracy and/or effectiveness. Example machine-learning models include various types of neural networks, decision trees, support vector machines, linear regression models, and Bayesian networks.

Relatedly, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items or smart topic outputs) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each performs tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a machine-learning model.

In addition, as used herein, the term “large language model” refers to a machine-learning model trained to perform computer tasks to generate or identify content items in response to trigger events (e.g., user interactions, such as text queries and button selections). In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., smart topic outputs) based on prompts and/or to identify content items based on various contextual data, including graph information from a knowledge graph and/or historical user account behavior. In some cases, a large language model comprises various commercially available models such as, but not limited to, GPT, ChatGPT, Llama, BERT, Claude, and Cohere.

Additionally, as used herein, the term “location-specific comment” refers to an annotation or remark that is associated with a location within a content item. Specifically, a location-specific comment references a particular portion of text, a phrase, a section, or an element of a content item to provide targeted feedback, clarification, or additional context. In some cases, a location-specific comment can overlay a content item to provide feedback at the location.

In addition, as used herein, the term “metadata layer” refers to an additional structure that overlays content to provide descriptive, contextual, or structural information about the underlying data. Specifically, the term “metadata layer” refers to metadata that is stored with a content item to provide metadata that is specific to locations within a content item. A metadata layer matches the size of a corresponding content item and includes location measurements that correspond to the locations within the content item.

As previously mentioned, the universal content integration system 100 generates a universal-content-integration tool that is overlaid on a content item. In particular, the universal content integration system 100 integrates with a third-party application to generate a universal-content-integration tool that overlays the content item within the third-party application and includes a large language model analysis option. FIG. 2 illustrates a schematic diagram of a universal content integration system 100 generating a universal-content-integration tool overlaid on a content item within a third-party application and utilizing a large language model to generate a response corresponding to a content item displayed in the third-party application accordance with one or more embodiments.

As shown in FIG. 2, the universal content integration system 100 generates universal-content-integration tool 206 overlaid on content item 204 within third-party application 202. Specifically, the universal content integration system 100 integrates with the third-party application 202 to generate the universal-content-integration tool 206 as a user interface element within third-party application 202. For example, the universal-content-integration tool 206 is not integrated within an interface of third-party application 202 but is a separate interface component overlaid on top of content item 204.

In some cases, the universal content integration system 100 is integrated with the third-party application 202 through an application programming interface (API). Through the API, the universal content integration system 100 instructs the third-party application 202 to generate universal-content-integration tool 206 as an interface component (or interface element) that is overlaid on the content item within third-party application 202. In other cases, universal-content-integration tool 206 is generated entirely by the universal content integration system 100 as an overlay on third-party application 202. In these cases, the universal-content-integration tool 206 is separate from third-party application 202 but is confined within third-party application 202 and moves with an interface of third-party application 202 (e.g., if third-party application 202 is minimized, the universal-content-integration tool 206 is minimized with third-party application 202).

In one or more embodiments, the universal-content-integration tool 206 is moveable within third-party application 202. More particularly, the universal-content-integration tool is not integrated within an interface of third-party application 202 but is a separate interface component overlaid on content item 204, and user interactions with the universal-content-integration tool 206 can move the universal-content-integration tool 206 within the third-party application 202. As an illustration, if the universal content integration system 100 generates the universal-content-integration tool 206 over a portion of content item 204 that a client device wants to access, the client device can perform a user interaction with universal-content-integration tool 206 to move (or relocate) the universal-content-integration tool 206 within a third-party application.

Further, in some embodiments, the universal-content-integration tool 206 is confined to a boundary within third-party application 202. Specifically, when the universal content integration system 100 generates the universal-content-integration tool 206, the universal content integration system 100 defines a boundary within which a user interaction may move the universal-content-integration tool 206. For instance, the universal content integration system 100 can define the boundary as the edges of third-party application 202. In other instances, the universal content integration system 100 can define a certain area within third-party application 202 that user interactions may move universal-content-integration tool 206, such as within a display area for content item 204. Indeed, the universal content integration system 100 limits the universal-content-integration tool 206 within third-party application 202 so it is clear which content item (and which application) universal-content-integration tool 206 is associated. For example, if multiple applications are utilizing a universal-content-integration tool, it is clear that universal-content-integration tool 206 is associated with content item 204 in third-party application 202, not an additional content item in an additional application. If a user interaction could move the universal-content-integration tool 206 outside the application, it would be easy to confuse to which application universal-content-integration tool 206 belongs.

As shown, the universal content integration system 100 utilizes large language model 210 to generate response 212. More specifically, based on a user interaction with large language model analysis option 208 in universal-content-integration tool 206, the universal content integration system 100 utilizes large language model 210 to analyze content item 204 to generate response 212. For example, large language model 210 can generate response 212 by generating a summary of content item 204. In addition to analyzing content item 204, large language model 210 can analyze interactions or content with universal-content-integration tool 206 and generate response 212 using the interactions or content. For instance, large language model 210 can generate a task list from location-specific comments associated with content item 204. In other instances, large language model 210 can generate a summary of location-specific comments or a history of interactions with content item 204 (by the client device displaying content item 204 or additional client devices associated with content item 204).

In addition, in some embodiments, large language model analysis option 208 can include an option to enter instructions for large language model 210 to perform a specified action with regards to content item 204. Specifically, within large language model analysis option 208, a client device can enter text instructing large language model 210 to perform a specified action. In some cases, a client device can receive instructions to perform an action in regard to third-party application 202. For instance, based on receiving an instruction to change the font in the content item, large language model 210 can generate and provide an instruction for third-party application 202 to change the fonts in the application to a specified font. In these cases, large language model 210 is connected to third-party application 202 through the API between third-party application 202 and the universal content integration system 100.

In addition, the universal content integration system 100 can access additional content within the content management system (e.g., content management system 102) and can utilize the content to update content item 204 using instructions large language model 210. Specifically, based on a user interaction with large language model analysis option 208, the universal content integration system 100 can utilize the large language model 210 to access specified content within the content management system and update content item 204 using the specified content. For instance, based on receiving a user instruction to “update the pictures in content item 204 to include my pictures of dolphins,” large language model 210 can identify the pictures of dolphins in a storage location of the content management system associated with a user account that is also associated with the client device. If large language model 210 identifies the pictures, large language model 210 will generate and provide instructions for third-party application 202 to replace pictures in content item 204 with the dolphin pictures.

As shown, the universal content integration system 100 can provide response 212 within universal-content-integration tool 206. Specifically, the universal content integration system 100 can update universal-content-integration tool 206 to include response 212. For example, as shown, the universal content integration system 100 can generate and display a task list corresponding to location-specific comments associated with content item 204. In addition, the universal content integration system 100 can include the text of a location-specific comment in universal-content-integration tool 206 and an indication 214 of the location-specific comment. Also, when the universal content integration system 100 utilizes large language model 210 to generate response 212 by updating content item 204, the universal content integration system 100 can display an indication 216 that indicates a change to content item 204. In other cases, the universal content integration system 100 can display a summary of content item 204 or content generated by large language model 210 regarding content item 204 (e.g., an answer to a question about content item 204, a requested calculation for content item 204, or other response based on user input in large language model analysis option 208).

In addition to displaying the response, the universal content integration system 100 also synchronizes the response between the universal content integration system 100 (or the content management system) and/or client devices associated with content item 204. Specifically, the universal content integration system 100 can utilize large language model 210 to generate a response for content item 204 and synchronize the response to additional client devices associated with content item 204. For example, when large language model 210 generates a task list, the task list is synchronized between additional client devices associated with content item 204 so that a user selection of a task from the task list is synchronized to the additional client devices (e.g., indicating a completed task).

As previously mentioned, the universal content integration system 100 generates a universal-content-integration tool. Specifically, the universal content integration system 100 generates a universal-content-integration tool as an overlay of a content item. FIGS. 3A-3B illustrate example graphical user interfaces of a universal-content-integration tool overlaid on a content item in accordance with one or more embodiments.

As shown in FIG. 3A, the universal content integration system 100 can provide an indication 304 for a universal-content-integration tool on content item 302 within interface 300. In particular, the universal content integration system 100 can provide indication 304 that, upon a user interaction with indication 304, generates a universal-content-integration tool. For example, indication 304 can be a smaller, or partial, version of the universal-content-integration tool. In some cases, indication 304 can include an indication of notifications, such as notifications of location-specific comments.

As shown in FIG. 3B, based on a user interaction with indication 304, the universal content integration system 100 can generate the universal-content-integration tool 306. Specifically, the universal content integration system 100 generates an expanded version of indication 304 that includes options for user interactions to generate engagements and interactions for the content item. For example, the universal-content-integration tool includes a status option, a location-specific comment option, a large language model analysis option, a share option, a synchronization status option, and a current viewer option.

As previously mentioned, in one or more embodiments, the universal content integration system 100 generates a universal-content integration tool that corresponds to an application or content item. More specifically, the universal content integration system 100 can generates a universal-content-integration tool with options that are specific to an application or content item. FIGS. 4A-4C illustrate example graphical user interfaces of a universal content integration system generating a universal-content-integration tool corresponding to an application or content item in accordance with one or more embodiments. Specifically, FIG. 4A illustrates a universal-content-integration tool that is specific to an application and FIGS. 4B-4C illustrate universal-content-integration tools that are specific to respective content items.

As illustrated in FIG. 4A, the universal content integration system 100 generates universal-content-integration tool 404 overlaid on content item 402 within application 400a. In particular, the universal content integration system 100 generate universal-content-integration tool 404 that comprises options that are specific to application 400a. For example, settings associated with universal-content-integration tool 404 for application 400a can indicate options for the universal content integration system 100 to include when generating universal-content-integration tool 404 in application 400a. In some instances, settings for a universal-content-integration tool 404 correspond to application 400a, so when the universal content integration system 100 generates a universal-content-integration tool in application 400a the universal-content-integration tool generates the same options (e.g., the same options for the application for all users using the application). In other instances, settings for application 400a are associated with a user account, so the universal content integration system 100 generates a user-defined set of options when generating universal-content-integration tool 404 within application 400a.

In one or more embodiments, settings for a universal-content-integration tool are specific to a content item. As shown in FIG. 4B, the universal content integration system 100 can generate universal-content-integration tool 410 overlaid on content item 408 for application 400b that includes options that are specific to content item 408. More particularly, based on settings stored at the universal content integration system 100 for content item 408, the universal content integration system 100 generates universal-content-integration tool 410 with options specific to content item 408. As also shown, settings for the universal-content-integration tool 410 can also include options for displaying location-specific comments, such as settings that indicate whether or not the universal content integration system 100 should display indications of location-specific comments 406 when generating universal-content-integration tool 410.

In addition, in one or more embodiments, the universal content integration system 100 generates a universal-content-integration tool that is specific to a content item even within the same application. As shown in FIG. 4C, the universal content integration system 100 generates universal-content-integration tool 414 that is specific to content item 412 in application 400b, even when (as shown in FIG. 4B, there is another window (or tab) within application 400b displaying content item 408 with universal-content-integration tool 410. Further, the universal content integration system 100 generates universal-content-integration tool 410 as an overlay with boundaries associated with content item 408 and universal-content-integration tool 414 as an overlay with boundaries specific to content item 412, so that changing windows will also change the displayed universal-content-integration tool.

As mentioned, in one or more embodiments, the universal content integration system 100 generates various options within a universal-content-integration tool for engagements and responses for the content item. For example, the universal content integration system 100 generates a content status option, a share option, and a current viewing option. FIG. 5 illustrates an example graphical user interface and various options of a universal content integration system 100 using a universal-content-integration tool to generate engagements and responses for a content item in accordance with one or more embodiments

As shown in FIG. 5, the universal content integration system 100 generates a content item status option 502 within universal-content-integration tool 504 that is overlaid on a content item in interface 500. In particular, the universal content integration system 100 generates content item status options that can update a status for a content item within a content management system from within an application that is not associated with the content management system. For example, the universal content integration system 100 synchronizes a status for the content management system that can be synchronized for the content item at other locations storing the content item, such as other client devices or other cloud storage locations.

In one or more embodiments, the universal content integration system 100 generates a content item status option that indicates a review status for the content item. An edit status can indicate the current stage or outcome of an evaluation process for the content item. For example, a review status can include “edits requested,” “in review,” “in progress,” “reviewed,” “completed,” or “approved.” Indeed, the universal content integration system 100 can update the status of a content item from within a third-party application and reflect the status across other locations storing the content item.

In addition, as shown, the universal content integration system 100 generates a share option 506 within a universal-content-integration tool 504. More specifically, the universal content integration system 100 generates a share option that can update share permissions for the content item within a content management system. For example, based on a user interaction with share option 506, the universal content integration system 100 can generate options for updating share permissions for the content item that include user accounts of the content management system that are allowed to view, edit, or are prohibited from accessing the content item.

As also shown, the universal content integration system 100 generates a current viewer option 508 within a universal-content-integration tool. More particularly, the universal content integration system 100 generates current viewer option 508 which indicates user accounts of the content management system interacting with the content item. For example, the universal content integration system 100 identifies a user account associated with the content management system that is currently viewing, editing, or otherwise interacting with the content item. To illustrate, if a client device associated with the content management system opens the content item, current viewer option 508 will generate an indication of the user account within current viewer option 508.

As previously mentioned, the universal content integration system 100 utilizes a universal-content-integration tool to generate location-specific comments for a content item. Specifically, the universal content integration system 100 generates a location-specific comment option within a universal-content-integration tool and generates location-specific comments at locations of a content item. FIGS. 6A-6C illustrate example graphical user interfaces for using a universal-content-integration tool to generate location-specific comments for a content item in accordance with one or more embodiments.

As shown in FIG. 6A, the universal content integration system 100 generates location-specific comment option 604 within a universal-content-integration tool overlaid on a content item within interface 600. In one or more embodiments, through location-specific comment option 604, the universal content integration system 100 generates location-specific comments 602 for a content item that provide feedback, a clarification, or an opinion that corresponds to a precise location of a content item. Specifically, the universal content integration system 100 generates a location-specific comment based on a user interaction at a precise location that corresponds to text, photos, or other elements of a content item. For example, a location-specific comment can correspond to a photo (e.g., based on the placement of the location-specific comment), and user-input text of the location-specific comment can include a remark, observation, or statement for the photo.

In one or more embodiments, an interaction with location-specific comment option 604 within a universal-content-integration tool generates an option to generate a location-specific comment based on a user interaction. Specifically, the universal content integration system 100 provides an option that allows a client device to provide a user input at a location of the content item to generate a location-specific comment. For example, a client device can place a location-specific comment near an object, text, photo, or element of a content item, indicating that the text (or other user input) of the location-specific comment corresponds to the object, text, photo, or element of the content item.

As shown, the universal content integration system 100 can generate an indication of a location-specific comment overlaid on a content item. More particularly, the universal content integration system 100 generates an indication of a location-specific comment overlaid on the comment item that corresponds to a location of the content item. For example, based on a user indicating a location for a location-specific comment, the universal content integration system 100 will generate an indication of the location-specific comment overlaid on the content item. Relatedly, in some embodiments, an indication of a location-specific comment includes an indication of a user account associated with the location-specific comment. For example, the universal content integration system 100 provides a photo, a name, or other symbol within the location-specific comment that corresponds to the user account and identifies that the location-specific comment belongs to the user account.

Further, in one or more embodiments, location-specific comments 602 can include location-specific comments from multiple user accounts. Specifically, location-specific comments 602 can include location-specific comments from a user account associated with the client device displaying the content item and location-specific comments from additional user accounts associated with the content item. For example, the universal content integration system 100 (or the content management system) stores indications (or metadata) of location-specific comments corresponding to a user account associated with the content item. Based on a user interaction with location-specific comment option 604, the universal content integration system 100 generates location-specific comments 602 by generating location-specific comments corresponding to the stored indications.

In some embodiments, the universal content integration system 100 stores a location of a location-specific comment by generating a metadata layer that includes indications of the location-specific comment. Specifically, the universal content integration system 100 generates a metadata layer that is a structural marker that associates location-specific comments with particular elements or content of a content item. For example, the universal content integration system 100 generates a metadata layer that maps the content item and, based on a user interaction indicating a precise location for a location-specific comment, generates an indication within the metadata layer corresponding to the precise location of the location-specific comment. Further, when a client device displays the content item, the universal content integration system 100 accesses the metadata layer to identify locations of the content item for stored location-specific comments and generate the location-specific comments overlaid on the content item at the locations of the content item using the metadata layer. Indeed, by using the metadata layer to generate location-specific comments overlaid on the content item at the precise locations, the universal content integration system 100 generates the location-specific comments at the specified location when generating the location-specific comments on additional client devices or during additional sessions of displaying the location-specific comments.

As shown in FIG. 6B, in some embodiments, the universal content integration system 100 displays an expanded location-specific comment 606. Specifically, based on a user interaction with an indication of a location-specific comment, the universal content integration system 100 generates expanded location-specific comment 606 that includes the substance of a location-specific comment, such as the text or other input that corresponds to the location. As shown, expanded location-specific comment 606 includes a comment to update a photo at the location of the location-specific comment to “add more vibrant imagery showcasing the nearby area.”

In addition, as shown in FIG. 6B, the universal content integration system 100 can also generate feedback options 608 within expanded location-specific comment 606. In one or more embodiments, the universal content integration system 100 generates feedback options as selectable options that can quickly convey a user reaction to the location-specific comment to express approval, disapproval, or sentiment. For example, the universal content integration system 100 can generate options with icons or other symbols corresponding to various emotions, sentiments, or status (e.g., approved, needs review) for the location-specific comment. In addition, in one or more embodiments, the universal content integration system 100 also provides options to provide text feedback for a location-specific comment. For example, by selecting option 610, the universal content integration system 100 generates options (or text spaces) to provide text feedback to the location-specific comment.

As shown in FIG. 6C, the universal content integration system 100 can also generate coded comments 612 with indications 618 of a user role associated with a user account for the comment. More particularly, the universal content integration system 100 generates coded comments that include a visual indication that identifies a user role associated with a user account for the comment. In some instances, a user role can include a role that is specific to the user account, such as team lead or supervisor. In other instances, a user role can indicate a team to which the user account belongs, such as an administrative team, a finance team, a marketing team, or a product design team. Further, a user role can correspond to the user role for the account with respect to the content item, such as a reviewer or editor. Moreover, a user role can relate to how the user account interacted with the content item, such as edited, approved, or requested edits.

As mentioned, and as shown in FIG. 6C, the universal content integration system 100 can generate coded comments 612 by including indications 618 as visual indicators of the user role associated with coded comments 612. In some cases, the universal content integration system 100 generates a indications 618 by providing a color corresponding to the user role (e.g., each user role corresponds to a different color). In other cases, the universal content integration system 100 generates indications 618 by using patterns, icons, label indicators, enhancements to a user icon (e.g., a unique border or color ring specific to the user role), or text formatting. In addition, the universal content integration system 100 can also provide a notification 614 that indicates a number of coded comments associated with a user role or team associated with indications 618. Indeed, by using visual enhancements, a user role associated with a coded comment is easily visible.

Moreover, as shown in FIG. 6C, the universal content integration system 100 can also provide filter options 616 to filter comments based on user role. For example, based on user selections of filter options 616, the universal content integration system 100 displays comments associated with selected user roles (or hides comments associated with user roles). In addition, the universal content integration system 100 can provide filter options for displaying coded comments based on recency, such as displaying newly (or recently) uploaded coded comments.

As previously mentioned, in one or more embodiments, the universal content integration system 100 utilizes a large language model to generate responses for the content item. Specifically, the universal content integration system 100 utilizes a large language model to analyze the content item and generate a response. FIG. 7 illustrates an example graphical user interface for universal content integration system 100 using a universal-content-integration tool to generate responses for a content item in accordance with one or more embodiments.

As shown, the universal content integration system 100 generates a universal-content-integration tool with large language model analysis option 702 within an interface 700 of an application (e.g., a third-party application). Based on receiving a user selection of large language model analysis option 702, the universal content integration system 100 utilizes a large language model to generate response 704 and response 706. More specifically, the universal content integration system 100 can utilize the large language model to generate responses for the content item, responses for user interactions with the content item, or responses for location-specific comments associated with the content item. For example, as shown, response 704 is a summary of location-specific comments for the content item, while response 706 is a task list generated from location-specific comments for the content item. Additional details regarding the universal content integration system 100 utilizing a large language model to generate responses are provided above with respect to FIG. 2.

In addition, the universal content integration system 100 can utilize the large language model analysis option 702 to generate additional responses corresponding to the content item or to generate responses to previously generated responses. For example, as shown, the universal content integration system 100 can provide user-input option 708 where a user can provide input for large language model to generate additional responses corresponding to the content item (e.g., asking questions about the content item) or additional response corresponding to response 704 and/or response 706 (e.g., asking questions about response 704 and/or response 706).

In one or more embodiments, the universal content integration system 100 generates a universal-content-integration tool that synchronizes across multiple applications. Specifically, the universal content integration system 100 stores data and information corresponding to the content item and generates a universal-content-integration tool that updates across multiple applications. FIG. 8 illustrates an example graphical user interface of the universal content integration system 100 displaying content integrations from a universal-content-integration tool on a content item in accordance with one or more embodiments.

As shown, the universal content integration system 100 generates universal-content-integration tool 806 for content item 802 in interface 800. Specifically, the universal content integration system 100 accesses stored information associated with the content item and generates universal-content-integration tool 806 using the stored metadata. For example, the universal content integration system 100 can include content item statuses, synchronization statuses, and share permissions and generates the universal-content-integration tool 806 to include the information. In addition, the universal content integration system 100 synchronizes universal-content-integration tool 806 with a server device (e.g., server device(s) 1002), so updates and modifications made to the content item on additional applications (or additional client devices) are reflected in universal-content-integration tool 806.

As previously mentioned, the universal content integration system 100 generates a metadata layer for a content item that includes locations for location-specific comments for a content item. In one or more embodiments, when the universal content integration system 100 generates universal-content-integration tool 806, the universal content integration system 100 accesses a metadata layer for the content item to generate location-specific comments 804. Specifically, the universal content integration system 100 utilizes the metadata layer to identify precise locations within content item 802 for location-specific comments 804. For example, location-specific comments 804 as shown in FIG. 8 correspond to locations of location-specific comments 602 in FIG. 6A. Indeed, the universal content integration system 100 generates location-specific comments 804 overlaid at precise locations across multiple applications.

In addition, in one or more embodiments, the universal content integration system 100 can also provide previews of content items in interface 800 when the client device does not have an application corresponding to the file type of the content item. Specifically, interface 800 is an interface of a desktop application of the content management system that can display content items for some specialized file types. For example, specialized file types require a source application to access a content item of the specialized file type. To illustrate, Adobe Photoshop is usually required to open a Photoshop file (. psd), but the universal content integration system 100 can open a Photoshop file in interface 800. In some cases, the universal content integration system 100 opens content item 802 as a display where the user can view the content item.

Further, in some embodiments, the universal content integration system 100 can generate additional content overlays for a content item of a specialized file type when displayed in interface 800. Specifically, the universal content integration system 100 can generate additional content overlays that provide feedback and details for content item 802 that can be accessed in the source application (e.g., Photoshop). For example, the universal content integration system 100 can provide a marker to make indications overlaid on content item 802 that appear when content item 802 is accessed in the source application. To illustrate, a client device that does not have Photoshop can provide a user interaction with a content overlay in interface 800 by using a content marker to indicate a portion of a Photoshop file to edit. When an additional client device accesses the content item in Photoshop, the universal content integration system 100 will display the marker as an overlay in Photoshop.

In addition, in one or more embodiments, the universal content integration system 100 generates a drop zone tool. In particular, the universal content integration system 100 generates a drop zone tool that can store and share content items with minimal user interactions from the desktop of a client device. FIGS. 9A-9B illustrate an example graphical user interface of the universal content integration system 100 generating a drop zone tool to store and share content items in accordance with one or more embodiments.

As shown in FIG. 9A, the universal content integration system 100 provides a menu option 904 within a system menu of a client device. Specifically, the universal content integration system 100 provides menu option 904 as an interactive option within a system menu that can generate a drop zone tool in response to specific user interactions. For example, as shown, the universal content integration system 100 can generate a drop zone tool in response to a user dragging content item 902 (or a shortcut to a content item representing a content item) over, or on top of, menu option 904 and, in response, the universal content integration system 100 generates a drop zone tool, as shown in FIG. 9B.

As shown in FIG. 9B, the universal content integration system 100 generates a drop zone tool 906 by generating interactive elements that correspond to specified actions. In some embodiments, elements of drop zone tool 906 can correspond to a storage location that, based on a user interaction in drop zone tool 906, can store a content item in the specified folder. For example, the universal content integration system 100 can generate element 908 that corresponds to a folder of a content management system (e.g., content management system 1004). Based on a user interaction of content item 902, such as dragging content item 902 over element 908, the universal content integration system 100 can store content item 902 (or a copy of content item 902) in the folder. In addition, in some cases, an element of drop zone tool 906 is a shared folder, as showed by element 910.

In addition, in one or more embodiments, the universal content integration system 100 elements of drop zone tool 906 correspond to a share option. For example, the universal content integration system 100 can generate element 912, which, based on a user interaction between content item 902 and element 912, shares the content item with an additional client device or a user account of the content management system.

In some embodiments, the universal content integration system 100 generates elements in drop zone tool 906 based on user preferences. Specifically, the universal content integration system 100 can generate a drop zone tool with elements that correspond to specific actions as defined in user preferences for the drop zone tool. For example, user preferences can indicate the options for specified actions to include in the drop zone tool, such as a specified folder or a specified method of sharing a content item (e.g., email, through the content management system, or via text message). Indeed, while existing systems for storing content items require navigating through multiple interfaces and multiple user interactions, the universal content integration system 100 allows for storing and sharing of content items through dragging a content item.

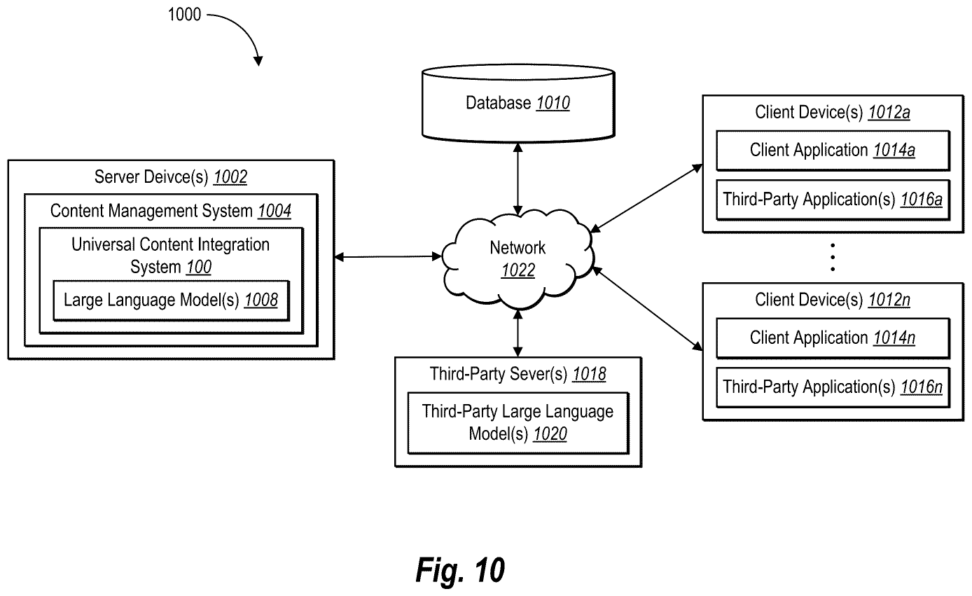

As previously mentioned, the universal content integration system generates a universal-content-integration tool overlaid on a content item rendered on a client device to generate dynamic omnichannel engagements and responses for the content item. In particular, the universal content integration system utilizes various devices, servers, and networks for storing, synchronizing, and communicating regarding content items. FIG. 10 illustrates a schematic diagram of an environment in which a universal content integration system can operate in accordance with one or more embodiments.

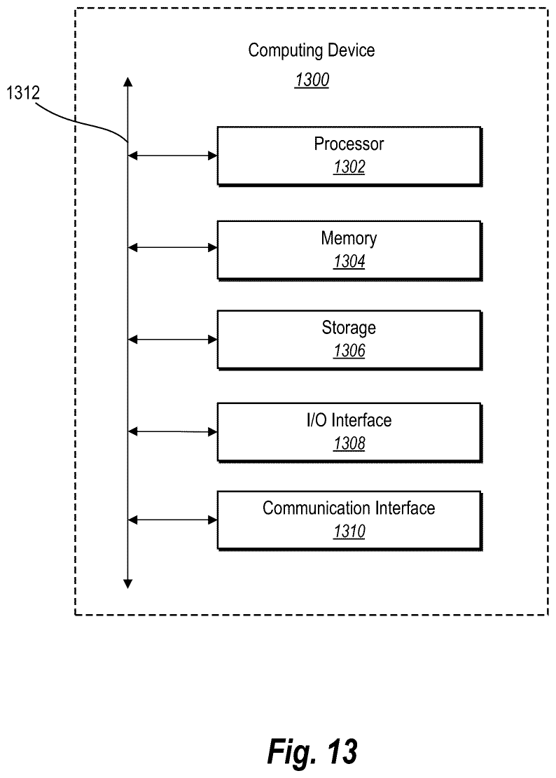

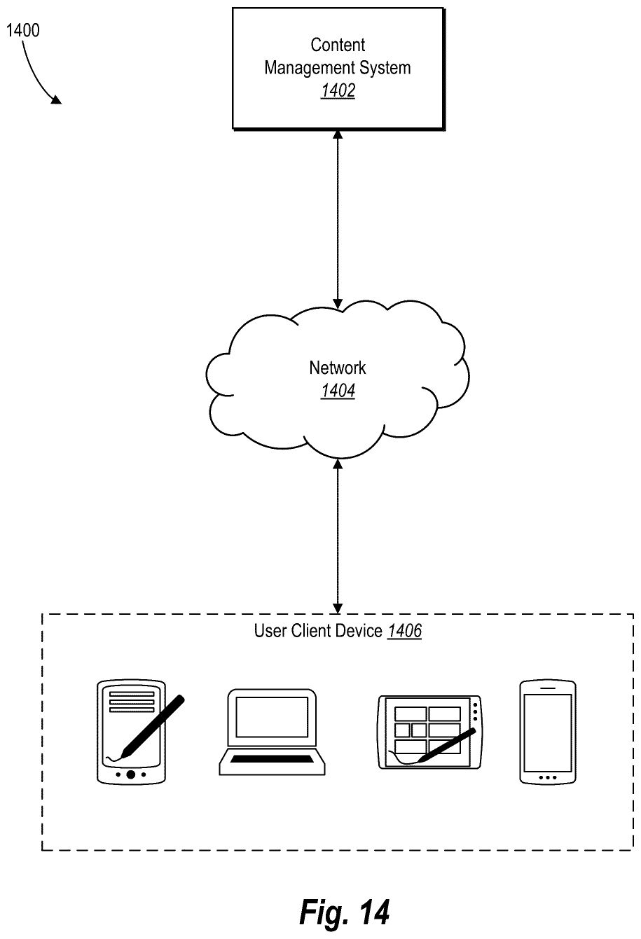

As shown, the environment 1000 includes server device(s) 1002, database 1010, client device(s) 1012a-1012n, and third-party server(s) 1018. Each of the components of the environment 1000 can communicate via network 1022, and network 1022 may be any suitable network over which computing devices can communicate. Example networks are discussed in more detail in relation to FIGS. 13-14.

As mentioned above, the environment 1000 includes client device(s) 1012a-1012n. The client device(s) 1012a-1012n can be one of a variety of computing devices, including a smartphone a tablet, a smart television, a desktop computer, a laptop computer, a virtual reality device, an augmented reality device, or another computing device as described in relation to FIGS. 13-14. The client device(s) 1012a-1012n can communicate with the server device(s) 1002 via network 1022. For example, the client device(s) 1012a-1012n can receive user input from a user interacting with client device(s) 1012a-1012n (e.g., via the client application(s) 1014a-1014n or third-party application(s)) to, for instance, receive user interactions with content items. In addition, the universal content integration system 100 or the server device(s) 1002 can receive information relating to various interactions with content items and/or user interface elements based on the input received by the client device(s) 1012a-1012n.

As shown, the client device(s) 1012a-1012n can include client application 1014a-1014n. In particular, the client application 1014a-1014n may be a web application, a native application installed on the client device(s) 1012a-1012n (e.g., a mobile application, a desktop application, etc.), or a cloud-based application where all or part of the functionality is performed by the server device(s) 1002. Based on instructions from the client application 1014a-1014n, the client device(s) 1012a-1012n can present or display information, including a user interface for interacting with content items and/or filenames of content items. Using the client application 1014a-1014n, the client device(s) 1012a-1012n can perform (or request to perform) various operations, such as generating a universal-content-integration tool overlaid on the content item within client application 1014a-1014n.

In addition, as shown, the client device(s) 1012a-1012n can also include third party application(s) 1016a-1016n. In particular, the third-party application(s) 1016a-1016n may be a web application, a native application installed on the client device(s) 1012a-1012n (e.g., a mobile application, a desktop application, etc.), or a cloud-based application where all or part of the functionality is performed by various third-party servers. Client device(s) 1012a-1012n can display content items stored on client device(s) 1012a-1012n through the third-party application(s) 1016a-1016n. Using the third-party application(s) 1016a-1016n, the client device(s) 1012a-1012n can perform (or request to perform) various operations, such as generating a universal-content-integration tool overlaid on the content item within third-party application(s) 1016a-1016n. The universal-content-integration tool within third-party application(s) 1016a-1016n—can communicate with server device(s) 1002 to, for example, store, modify, or update metadata corresponding to engagements and responses for the content item.

As further illustrated in FIG. 10, the environment 1000 includes the third-party server(s) 1018 that host the third-party large language model(s) 1020. In particular, the third-party machine-learning model(s) 1020 communicates with the server device(s) 1002, the client device(s) 1012a-1012n, and/or the database 1010 for the universal content integration system 100 to generate responses for a content item. For example, the universal content integration system 100 provides domain-specific language segments to the third-party machine-learning model(s) 1020, where the domain-specific language segments indicate data for generating results for various subcomponents. In some cases, the third-party machine-learning model(s) 1020 can refer to various third-party machine-learning models (e.g., ChatGPT, Gemini, Claude, LLaMA, Mistral, Command, Falcon, Stable LM, AI21 Labs, or XGen).

As illustrated in FIG. 10, the environment 1000 also includes the server device(s) 1002. The server device(s) 1002 may generate, track, store, process, receive, and transmit electronic data, such as metadata for content items corresponding to various engagements and responses for a content item, interactions with interface elements, and/or interactions between user accounts or client devices. For example, the server device(s) 1002 may receive an indication from the client device(s) 1012a-1012n of a user interaction modifying the internal content of a content item, an update to status and/or share permissions, selections of options for edit requests for a content item, or location-specific comments. In addition, the server device(s) 1002 can transmit data to the client device(s) 1012a-1012n in the form of a universal-content-integration tool. Indeed, the server device(s) 1002 can communicate with the client device(s) 1012a-1012n to send and/or receive data via network 1022. In some implementations, the server device(s) 1002 comprise(s) a distributed server where the server device(s) 1002 include(s) a number of server devices distributed across the network 1022 and located in different physical locations. The server device(s) 1002 can comprise one or more content servers, application servers, container orchestration servers, communication servers, web-hosting servers, machine learning servers, and other types of servers.

As shown in FIG. 10, the server device(s) 1002 can also include the universal content integration system 100 as part of the content management system 1004. The content management system 1004 can communicate with the client device(s) 1012a-1012n to perform various functions associated with the client application(s) 1014a-1014n, such as managing user accounts and/or identifying content items. Indeed, content management system 1004 can include a network-based smart cloud storage system to manage, store, and maintain content items and related data across numerous user accounts. In some embodiments, the universal content integration system and/or the content management system 1004 utilize the database 1010 to store and access information such as content items and/or metadata corresponding to content items indicating engagements and responses for the content item from a universal-content-integration tool.

In addition, as shown, the universal content integration system 100 can include the large language model 1008. In particular, large language model 1008 is local to (e.g., a part of or integrated within) the universal content integration system 100. In some cases, large language model 1008 is trained or tuned to generate responses for content items based on user interactions with a universal-content-integration tool. The universal content integration system 100 (or the content management system 1004) utilizes large language model 1008 to generate responses locally within the universal content integration system 100 (or the content management system 1004). Indeed, the universal content integration system 100 trains, maintains, and manages the workload of large language model 1008.

Although FIG. 10 depicts the universal content integration system located on the server device(s) 1002, in some implementations, the universal content integration system may be implemented by (e.g., located entirely or in part on) one or more other components of the environment. For example, the universal content integration system may be implemented as part of client device(s) 1012a-1012n and/or a third-party system. As another example, the client device(s) 1012a-1012n and/or a third-party system can download all or part of the universal content integration system 100 for implementation independent of, or together with, the server device(s) 1002.

In some implementations, though not illustrated in FIG. 10, the environment 1000 may have a different arrangement of components and/or may have a different number or set of components altogether. For example, the client device(s) 1012a-1012n may communicate directly with the universal content integration system, bypassing network 1022. The environment 1000 may also include one or more third-party systems, each corresponding to a different data source. In addition, the environment 1000 can include the database 1010 located external to the server device(s) 1002 (e.g., in communication via the network 1022) or located on the server device(s) 1002 and/or on the client device(s) 1012a-1012n.

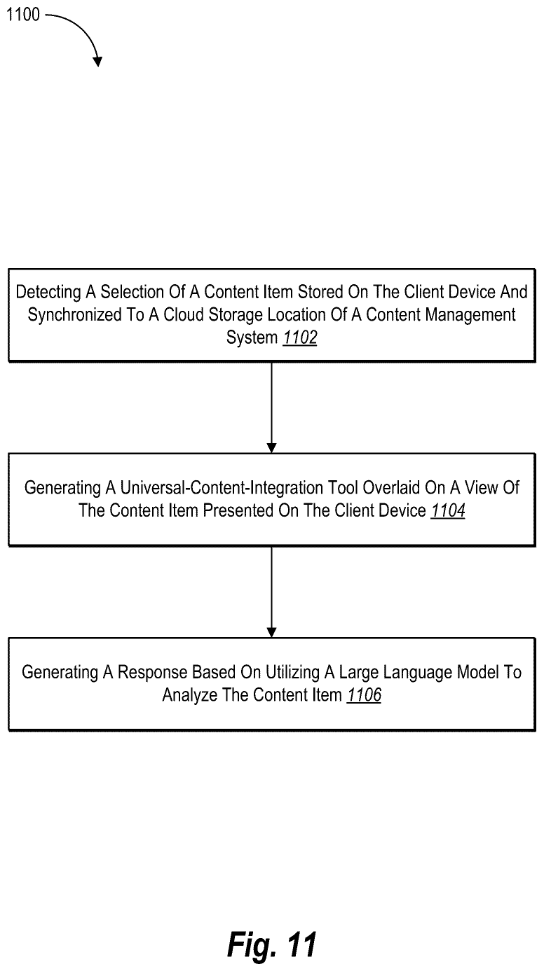

FIGS. 1-10, the corresponding text, and the examples provide a number of different methods, systems, devices, and non-transitory computer-readable media of the universal content integration system. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

As mentioned, FIG. 11 illustrates a flowchart of a series of acts 1100 for generating a universal-content-integration tool overlaid on a content item rendered on a client device to generate dynamic omnichannel engagements and responses for the content item in accordance with one or more embodiments. While FIG. 11 illustrates acts according to one embodiment, alternative embodiments may omit, add to, reorder, and/or modify any of the acts shown in FIG. 11. The acts of FIG. 11 can be performed as part of a method. Alternatively, a non-transitory computer-readable medium can comprise instructions that, when executed by one or more processors, cause a computing device to perform the acts of FIG. 11. In some embodiments, a system can perform the acts of FIG. 11.

As shown in FIG. 11, the series of acts 1100 includes an act 1102 of detecting a selection of a content item stored on the client device and synchronized to a cloud storage location of a content management system, an act 1104 of generating a universal-content-integration tool overlaid on a view of the content item present on the client device, and an act 1106 of generating a response based on utilizing a large language model to analyze the content item.

In particular, the act 1102 can include detecting, from a client device, a selection of a content item stored on the client device and synchronized to a cloud storage location of a content management system, the act 1104 can include generating, in response to the selection of the content item and based on the content item being synchronized to the cloud storage location of the content management system, a universal-content-integration tool overlaid on a view of the content item presented on the client device, the universal-content-integration tool comprising a large language model analysis option, and the act 1106 can include in response to an interaction with a large language model analysis option within the universal-content-integration tool, generating a response based on utilizing a large language model to analyze the content item.

In addition, in one or more embodiments, the series of acts 1100 includes generating the response utilizing the large language model further comprises receiving, from additional client devices associated with the content item, user interactions with the content item and generating the response based on utilizing the large language model to analyze the user interactions with the content item.

Also, in one or more embodiments, the series of acts 1100 includes generating one or more of a summary of the content item, a summary of one or more location-specific comments corresponding for the content item, and a list of tasks corresponding to location-specific comments associated with the content item.

Moreover, in one or more embodiments, the series of acts 1100 includes receiving the interaction with the large language model analysis option within the universal-content-integration tool by receiving, from the client device and within the universal-content-integration tool, a request to modify the content item; generating the response utilizing the large language model to analyze the content item based on the request to update the content item and generating an updated content item by utilizing the large language model to interact with a third-party application displaying the content item to modify the content item based on the request. Additionally, in one or more embodiments, the series of acts 1100 includes determining that an additional content item synchronized to the cloud storage location of the content management system is associated with the request to update the content item and generating the updated content item by modifying the content item using the additional content item. Also, in one or more embodiments, the series of acts 1100 includes providing, within the third-party application on the client device, the updated content item and synchronizing the updated content item to the cloud storage location of the content management system.

Further, in one or more embodiments, the series of acts 1100 includes identifying one or more location-specific comments for the content item and generating the response by utilizing the large language model to analyze the one or more location-specific comments for the content item. Moreover, in one or more embodiments, the series of acts 1100 includes generating the response utilizing the large language model to generate a sentiment for the one or more location-specific comments and providing, within the universal-content-integration tool, the sentiment for the one or more location-specific comments with the response.

Additionally, in one or more embodiments, the series of acts 1100 includes identifying one or more modifications to the content item by one or more additional client devices, generating the response by utilizing the large language model to generate a summary of the one or more modifications to the content item, and providing, within the universal-content-integration tool, the summary of the one or more modifications to the content item and an indication of the one or more additional client devices that modified the content item.

Moreover, in one or more embodiments, the series of acts 1100 includes detecting, from a client device, a selection of a content item stored on the client device and synchronized to a cloud storage location of a content management system, generating, in response to the selection of the content item and based on the content item being synchronized to the cloud storage location of the content management system, a universal-content-integration tool overlaid on a view of the content item within a third-party application displaying the content item on the client device, and in response to a user interaction with the universal-content-integration tool, updating the content item at a server the content management system.

Also, in one or more embodiments, the series of acts 1100 includes receiving the user interaction with the universal-content-integration tool by receiving a user interaction with a content item ss of the universal-content-integration tool, and in response to receiving the user interaction with the content item status option of the universal-content-integration tool, updating the content item at the content management system by updating a status of the content item with the content management system.

Moreover, in one or more embodiments, the series of acts 1100 includes receiving the user interaction with the universal-content-integration tool by receiving a user interaction with a synchronization status option of the universal-content-integration tool and in response to receiving the user interaction with the synchronization status option of the universal-content-integration tool, updating the content item at the server of the content management system by updating a synchronization status for the content item at the server of the content management system.

Furthermore, in one or more embodiments, the series of acts 1100 includes receiving the user interaction with universal-content-integration tool by receiving an interaction with a share option within the universal-content-integration tool and, in response to receiving a user interaction with a share option of the share option within the universal-content-integration tool, updating the content item at the server of the content management system by updating share permissions for the content item at the server of the content management system.

In addition, in one or more embodiments, the series of acts 1100 includes receiving the user interaction with universal-content-integration tool by receiving an interaction with a current viewer element within the universal-content-integration tool, in response to receiving a user interaction with the current viewer element within the universal-content-integration tool, providing indications of user accounts associated with client devices that are viewing the content item, and updating the content item at the server of the content management system by updating viewers of the content item at the server of the content management system.

FIGS. 1-11, the corresponding text, and the examples provide a number of different methods, systems, devices, and non-transitory computer-readable media of the universal content integration system. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

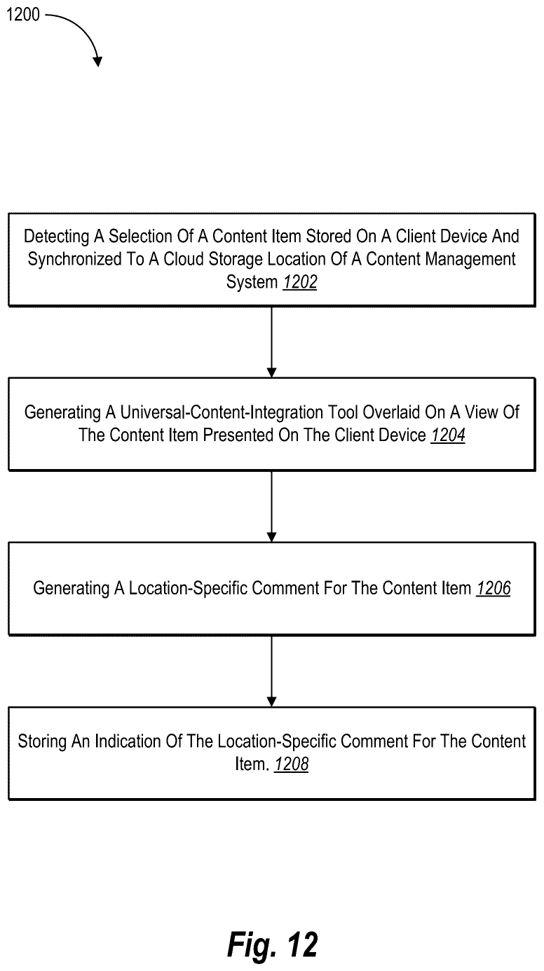

As mentioned, FIG. 12 illustrates a flowchart of a series of acts 1200 for generating a universal-content-integration tool overlaid on a content item rendered on a client device and generating location-specific comments in accordance with one or more embodiments. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer-readable medium can comprise instructions that, when executed by one or more processors, cause a computing device to perform the acts of FIG. 12. In some embodiments, a system can perform the acts of FIG. 12.

As shown in FIG. 11, the series of acts 1200 includes an act 1202 of detecting a selection of a content item stored on a client device and synchronized to a cloud storage location of a content management system, an act 1204 of generating a universal-content-integration tool overlaid on a view of the content item presented on the client device, an act 1206 of generating a location-specific comment for the content item, and an act 1208 of storing an indication of the location-specific comment for the content item.

In particular, the act 1202 can include detecting, from a client device, a selection of a content item stored on the client device and synchronized to a cloud storage location of a content management system, the act 1204 can include generating, in response to the selection of the content item and based on the content item being synchronized to the cloud storage location of the content management system, a universal-content-integration tool overlaid on a view of the content item presented on the client device, the act 1206 can include in response to an interaction with a location-specific comment option within the universal-content-integration tool, generating a location-specific comment for the content item, and the act 1208 can include storing, within the content management system, an indication of the location-specific comment for the content item.

Additionally, in one or more embodiments, the series of acts 1200 includes receiving a user interaction at a location of the content item and generating the location-specific comment corresponding to the location of the content item.

Also, in one or more embodiments, the series of acts 1200 includes generating a metadata layer for the content item comprising a location of the content item for the location-specific comment and storing the indication of the location-specific comment by storing the metadata layer with the content item within the content management system.

In addition, in one or more embodiments, the series of acts 1200 includes receiving a request to access the content item within an interface of the content management system, generating, based on the location of the content item for the location-specific comment within the metadata layer, an indication of the location-specific comment for the location of the content item for the location of the content item, and providing, within an interface of the content management system, an indication of the location-specific comment with the content item within the interface of the content management system.

Furthermore, in one or more embodiments, the series of acts 1200 includes providing, overlaid on the view of content item on the client device, an indication of the location-specific comment and an additional indication of a user account associated with the location-specific comment.

Moreover, in one or more embodiments, the series of acts 1200 includes receiving, from a server of the content management system, an additional location-specific comment for the content item corresponding to an additional client device and providing, for display on the client device, an indication of the location-specific comment corresponding to the client device and an indication of the additional location-specific comment corresponding to the additional client device.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., server device(s) 1002, client devices 1012 a-n, and third-party server(s) 1018). In one or more embodiments, the computing device 1300 may be a mobile device (e.g., a mobile telephone, a smartphone, a PDA, a tablet, a laptop, a camera, a tracker, a watch, a wearable device, etc.). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1312. The bus 1312 can include hardware, software, or both that connects components of computing device 1300 to each other.

FIG. 14 is a schematic diagram illustrating environment 1400 within which one or more implementations of the universal content integration system 100 can be implemented. For example, the universal content integration system 100 may be part of a content management system 1402 (e.g., the content management system 1004 or the content management system 102). Content management system 1402 may generate, store, manage, receive, and send digital content (such as digital content items). For example, content management system 1402 may send and receive digital content to and from client devices 1406 by way of network 1404. In particular, content management system 1402 can store and manage a collection of digital content. Content management system 1402 can manage the sharing of digital content between computing devices associated with a plurality of users. For instance, content management system 1402 can facilitate a user sharing a digital content with another user of content management system 1402.

In particular, content management system 1402 can manage synchronizing digital content across multiple client devices 1406 associated with one or more users. For example, a user may edit digital content using client device 1406. The content management system 1402 can cause client device 1406 to send the edited digital content to content management system 1402. Content management system 1402 then synchronizes the edited digital content on one or more additional computing devices.

In addition to synchronizing digital content across multiple devices, one or more implementations of content management system 1402 can provide an efficient storage option for users that have large collections of digital content. For example, content management system 1402 can store a collection of digital content on content management system 1402, while the client device 1406 only stores reduced-sized versions of the digital content. A user can navigate and browse the reduced-sized versions (e.g., a thumbnail of a digital image) of the digital content on client device 1406. In particular, one way in which a user can experience digital content is to browse the reduced-sized versions of the digital content on client device 1406.

Another way in which a user can experience digital content is to select a reduced-size version of digital content to request the full-or high-resolution version of digital content from content management system 1402. In particular, upon a user selecting a reduced-sized version of digital content, client device 1406 sends a request to content management system 1402 requesting the digital content associated with the reduced-sized version of the digital content. Content management system 1402 can respond to the request by sending the digital content to client device 1406. Client device 1406, upon receiving the digital content, can then present the digital content to the user. In this way, a user can have access to large collections of digital content while minimizing the amount of resources used on client device 1406.

Client device 1406 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. Client device 1406 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1404.

Network 1404 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1406 may access content management system 1402.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
detecting, from a client device, a selection of a content item stored on the client device and synchronized to a cloud storage location of a content management system;
generating, in response to the selection of the content item and based on the content item being synchronized to the cloud storage location of the content management system, a universal-content-integration tool overlaid on a view of the content item presented on the client device, the universal-content-integration tool comprising a large language model analysis option; and
in response to an interaction with a large language model analysis option within the universal-content-integration tool, generating a response based on utilizing a large language model to analyze the content item.

2. The computer-implemented method of claim 1, wherein generating the response utilizing the large language model further comprises:
receiving, from additional client devices associated with the content item, user interactions with the content item; and
generating the response based on utilizing the large language model to analyze the user interactions with the content item.

3. The computer-implemented method of claim 1, wherein generating the response further comprises generating one or more of a summary of the content item, a summary of one or more location-specific comments corresponding for the content item, and a list of tasks corresponding to location-specific comments associated with the content item.

4. The computer-implemented method of claim 1, further comprising:
receiving the interaction with the large language model analysis option within the universal-content-integration tool by receiving, from the client device and within the universal-content-integration tool, a request to modify the content item;
generating the response utilizing the large language model to analyze the content item based on the request to update the content item; and
generating an updated content item by utilizing the large language model to interact with a third-party application displaying the content item to modify the content item based on the request.

5. The computer-implemented method of claim 4, further comprising:
determining that an additional content item synchronized to the cloud storage location of the content management system is associated with the request to update the content item; and
generating the updated content item by modifying the content item using the additional content item.

6. The computer-implemented method of claim 4, further comprising:
providing, within the third-party application on the client device, the updated content item; and
synchronizing the updated content item to the cloud storage location of the content management system.

7. The computer-implemented method of claim 1, wherein generating the response based on utilizing the large language model to analyze the content item further comprises:
identifying one or more location-specific comments for the content item; and
generating the response by utilizing the large language model to analyze the one or more location-specific comments for the content item.

8. The computer-implemented method of claim 7, further comprising:
generating the response utilizing the large language model to generate a sentiment for the one or more location-specific comments; and
providing, within the universal-content-integration tool, the sentiment for the one or more location-specific comments with the response.

9. The computer-implemented method of claim 1, wherein generating the response further comprises:
identifying one or more modifications to the content item by one or more additional client devices;
generating the response by utilizing the large language model to generate a summary of the one or more modifications to the content item; and
providing, within the universal-content-integration tool, the summary of the one or more modifications to the content item and an indication of the one or more additional client devices that modified the content item.

10. A non-transitory computer-readable medium storing instructions that, when executed by at least one processor, cause a computer system to:
detect, from a client device, a selection of a content item stored on the client device and synchronized to a cloud storage location of a content management system;
generate, in response to the selection of the content item and based on the content item being synchronized to the cloud storage location of the content management system, a universal-content-integration tool overlaid on a view of the content item presented on the client device;
in response to an interaction with a location-specific comment option within the universal-content-integration tool, generate a location-specific comment for the content item; and
store, within the content management system, an indication of the location-specific comment for the content item.

11. The non-transitory computer-readable medium of claim 10, further comprising instructions that, when executed by the at least one processor, cause the computer system to generate the location-specific comment by:
receiving a user interaction at a location of the content item; and
generating the location-specific comment corresponding to the location of the content item.

12. The non-transitory computer-readable medium of claim 10, further comprising instructions that, when executed by the at least one processor, cause the computer system to:
generate a metadata layer for the content item comprising a location of the content item for the location-specific comment; and
store the indication of the location-specific comment by storing the metadata layer with the content item within the content management system.

13. The non-transitory computer-readable medium of claim 12, further comprising instructions that, when executed by the at least one processor, cause the computer system to:
receive a request to access the content item within an interface of the content management system;
generate, based on the location of the content item for the location-specific comment within the metadata layer, an indication of the location-specific comment for the location of the content item for the location of the content item; and
provide, within an interface of the content management system, an indication of the location-specific comment with the content item within the interface of the content management system.

14. The non-transitory computer-readable medium of claim 10, further comprising instructions that, when executed by the at least one processor, cause the computer system to provide, overlaid on the view of content item on the client device, an indication of the location-specific comment and an additional indication of a user account associated with the location-specific comment.

15. The non-transitory computer-readable medium of claim 10, further comprising instructions that, when executed by the at least one processor, cause the computer system to:
receive, from a server of the content management system, an additional location-specific comment for the content item corresponding to an additional client device; and
provide, for display on the client device, an indication of the location-specific comment corresponding to the client device and an indication of the additional location-specific comment corresponding to the additional client device.

16. A system comprising:
at least one processor; and
at least one non-transitory computer-readable storage medium storing instructions that, when executed by the at least one processor, cause the system to:
detect, from a client device, a selection of a content item stored on the client device and synchronized to a cloud storage location of a content management system;
generate, in response to the selection of the content item and based on the content item being synchronized to the cloud storage location of the content management system, a universal-content-integration tool overlaid on a view of the content item within a third-party application displaying the content item on the client device; and
in response to a user interaction with the universal-content-integration tool, update the content item at a server the content management system.

17. The system of claim 16, further comprising instructions that, when executed by the at least one processor, cause the system to:
receive the user interaction with the universal-content-integration tool by receiving a user interaction with a content item status option of the universal-content-integration tool; and
in response to receiving the user interaction with the content item status option of the universal-content-integration tool, update the content item at the content management system by updating a status of the content item with the content management system.

18. The system of claim 16, further comprising instructions that, when executed by the at least one processor, cause the system to:
receive the user interaction with the universal-content-integration tool by receiving a user interaction with a synchronization status option of the universal-content-integration tool; and
in response to receiving the user interaction with the synchronization status option of the universal-content-integration tool, update the content item at the server of the content management system by updating a synchronization status for the content item at the server of the content management system.

19. The system of claim 16, further comprising instructions that, when executed by the at least one processor, cause the system to:
receive the user interaction with universal-content-integration tool by receiving an interaction with a share option within the universal-content-integration tool; and
in response to receiving a user interaction with a share option of the share option within the universal-content-integration tool, update the content item at the server of the content management system by updating share permissions for the content item at the server of the content management system.

20. The system of claim 16, further comprising instructions that, when executed by the at least one processor, cause the system to:
receive the user interaction with universal-content-integration tool by receiving an interaction with a current viewer option within the universal-content-integration tool;
in response to receiving a user interaction with the current viewer option within the universal-content-integration tool, provide indications of user accounts associated with client devices that are viewing the content item; and
update the content item at the server of the content management system by updating viewers of the content item at the server of the content management system.
